(19) United States
(12) Patent Application Publication
(10) Pub. No.: US 2015/0098394 A1
(43) Pub. Date: Apr. 9, 2015

(54) IMS CENTRALIZED SERVICES (ICS) INTERWORKING FUNCTION (IWF) SYSTEM AND METHOD

(71) Applicant: Mavenir Systems, Inc., Richardson, TX (US)

(72) Inventors: Steven Wayne Corcoran, McKinney, TX (US); Terence Patrick McCabe, Dallas, TX (US); Anish Sharma, Bangalore (IN)

(73) Assignee: Mavenir Systems, Inc., Richardson, TX (US)

(21) Appl. No.: 14/149,923

(22) Filed: Jan. 8, 2014

(30) Foreign Application Priority Data
Oct. 8, 2013 (IN) 4555/CHE/2013

(51) Int. Cl. H04W 48/18

(52) U.S. Cl. CPC H04W 48/18
USPC 370/329

(57) ABSTRACT

An IP Multimedia Subsystem (IMS) Centralized Services (ICS) Interworking Function (IWF) element comprises an i2 interface to an IMS core network, an i3 interface to a Telephony Application Server (TAS), a Mobile Applications Part-G (MAP-G) interface to a Mobile

Switching Center (MSC) for retrieving subscriber identity, a MAP interface to a Home Location Register (HLR) for location management, subscriber management and call handling procedures, and an Sv interface to a Mobility Management Entity (MME) for appearing as a Visitor Location Register (VLR).

### FIELD

This patent application claims priority to Indian Patent Application No. 4555/CHE/2013 filed on Oct. 8, 2013.

The present disclosure primarily relates to a IP Multimedia Subsystem (IMS) Centralized Services (ICS) Interworking Function (IWF) system and method.

### BACKGROUND

3GPP TS 23.292 specifies the architectural requirements for delivery of consistent services to the user regardless of the attached access network type (e.g., Circuit-Switched or Packet-Switched domains). This is achieved by implementing the services in the IP Multimedia Subsystem (IMS). IMS Centralized Services (ICS) provides communication services such that all services, and service control, are only based on IMS mechanisms and enablers. It enables IMS services when using Circuit-Switched (CS) access (e.g. TS 24.008, 3GPP2 C.S0001-D) or IP-based access networks. User sessions are controlled in IMS via PS or CS access and can be any of those defined in clause 22.4 of TS 22.101. When using a CS access network, or when using a PS access network that does not support the full duplex speech/video component of an IMS-based service, the CS core network is utilized to establish a circuit bearer for use as media for IMS sessions. The transmission of both bidirectional and unidirectional real-time video media flows are supported. As a result, the subscriber's service experience is the same regardless of access via the CS or PS domain. Further, the subscriber's services are maintained seamlessly and transparently when transitioning or roaming across different domains while in an active session.

LTE represents a dramatic departure from Circuit-Switched 2G and 3G networks. Previous voice standards, such as those available from the Global System for Mobile (GSM) communications, provide dedicated channels for Circuit-Switched telephony. LTE, however, provides an end-to-end all-IP connection from handsets or other devices to the core network and back. The mobile industry has reached consensus around a long-term migration strategy to LTE based on IP Multimedia Subsystem (IMS), the 3GPP architecture that allows mobile operators to run voice, video, chat, and other real-time Session Initiation Protocol (SIP)-based services over an all-IP network. This new architecture necessitates large capital and operational expenditures to upgrade or replace network platforms and software. According to a recent report, 35 percent of mobile operators will deploy VoLTE by 2013 despite these costs, deciding that the enhanced quality of experience is a significant competitive differentiator. With the requirement by mobile operators to simultaneously support existing 2G and 3G Circuit-Switched and 4G LTE Packet-Switched infrastructures due to the prohibitive costs of completely replacing the older network infrastructure with the newer one, interim solutions for 2G and 3G voice and VoLTE have been introduced. ICS is part of that solution.

### SUMMARY

An IP Multimedia Subsystem (IMS) Centralized Services (ICS) Interworking Function (IWF) element comprises an i2 interface to an IMS core network, an i3 interface to a Telephony Application Server (TAS), a Mobile Applications Part-G (MAP-G) interface to a Mobile Switching Center (MSC) for retrieving subscriber identity, a MAP interface to a Home Location Register (HLR) for location management, subscriber management and call handling procedures, and an Sv interface to a Mobility Management Entity (MME) for appearing as a Visitor Location Register (VLR).

An method for IP Multimedia Subsystem (IMS) Centralized Services (ICS) Interworking Function (IWF) comprises interfacing with an IMS core network using an i2 interface, interfacing with a Telephony Application Server (TAS) using an i3 interface, interfacing with a Mobile Switching Center (MSC) for retrieving subscriber identity using a Mobile Application Part-G (MAP-G) interface, interfacing with a Home Location Register (HLR) for location management, subscriber management and call handling procedures using a MAP interface, and interfacing with a Mobility Management Entity (MME) for appearing as a Visitor Location Register (VLR) using an Sv interface.

### DESCRIPTION OF THE DRAWINGS

FIG. 1 is a simplified block diagram of an exemplary embodiment of the IMS Centralized Services (ICS) architecture according to the present disclosure;

FIG. 2 is a simplified block diagram of an exemplary embodiment of ICS IWF (Interworking Function) interfaces according to the present disclosure;

FIGS. 3-5 are simplified block diagrams of an exemplary embodiment of MSC (Mobile Switching Center) evolution according to the present disclosure;

FIG. 6 is a simplified block diagram of an exemplary embodiment of ICS IWF/GW optimized for SIP/IP according to the present disclosure;

FIG. 7 is a simplified block diagram of an exemplary embodiment of a IMS beyond VoLTE according to the present disclosure;

FIG. 8 is a simplified block diagram of an exemplary embodiment of registration of a pre-Release 6 UE with default domain set to CS according to the present disclosure;

FIG. 9 is a simplified block diagram of an exemplary embodiment of registration of a Release 6 UE with ICS enabled according to the present disclosure;

FIG. 10 is a simplified block diagram of an exemplary embodiment of mobile originated ICS call according to the present disclosure; and

FIG. 11 is a simplified block diagram of an exemplary embodiment of mobile terminated ICS call according to the present disclosure.

### DETAILED DESCRIPTION

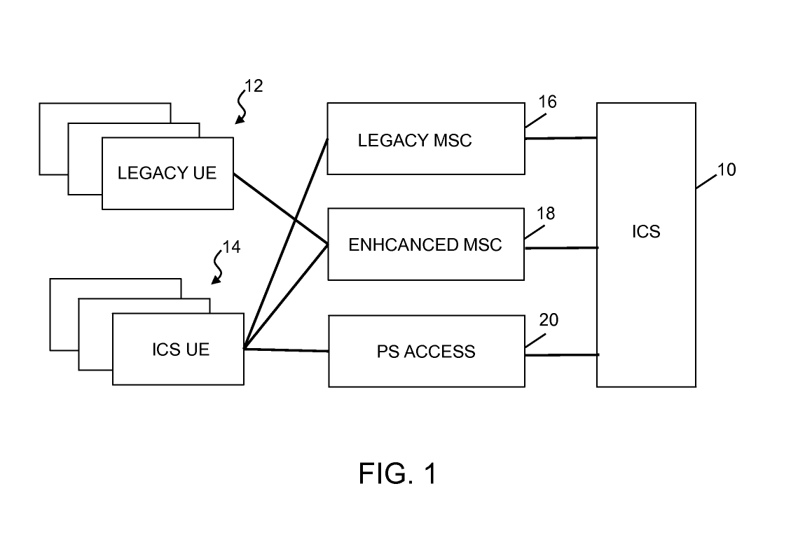

FIG. 1 is a simplified block diagram of an exemplary embodiment of the IMS (IP Multimedia Subsystem) Centralized Services (ICS) architecture 10 according to the present disclosure. 3GPP (3rd Generation Partnership Project) defined IMS as the service engine for next-generation IP (Internet Protocol) networks. ICS enables IMS services for traditional circuit switched (CS) voice access by legacy 2G, 3G, and fixed User Equipment (UE) 12, such as PSTN (Public Switched Telephone Network) and GSM (Global System for Mobile) telephones. With ICS, user sessions are anchored in the IMS network when UEs access via Packet-Switched (PS) access networks 20 or CS access networks, which may be wireless technologies, wireline technologies, and broadband access technologies. For the purpose of the present disclosure, the access technologies may include, for example, radio access technologies selected from IEEE 802.11a technology, IEEE 802.11b technology, IEEE 802.11g technology, IEEE 802.11n technology, GSM/EDGE Radio Access Network (GERAN) technology (both CS and PS domains), Universal Mobile Telecommunications System (UMTS) technology, and Evolution-Data Optimized (EVDO) technology, etc. The UEs can be enhanced UEs 14 that support ICS capability, but UEs 12 without ICS capability are also supported by ICS. Broadband access technologies may include wireless local area networks or WLANs, Wi-MAX networks as well as fixed networks such as DSL, cable broadband, etc. With ICS, IMS sessions using CS media bearer are treated as standard IMS sessions for the purpose of service control and service continuity. The 3GPP ICS standard defines signaling mechanisms between the UE and IMS network for service continuity when using Circuit-Switched access for media transport.

The network includes legacy MSC (Mobile Switching Center) servers 16, as well as enhanced MSC servers 18 that have been enhanced to support ICS. MSCs enhanced for ICS support both mobile-originated and mobile-terminated calls for ICS UEs 14 and non-ICS UEs 12. Enhanced MSC 18 may act as an IMS client for the UE, or via an Intelligent Network (IN) node that communicates with the MSC server via CAP (CAMEL Application Part).

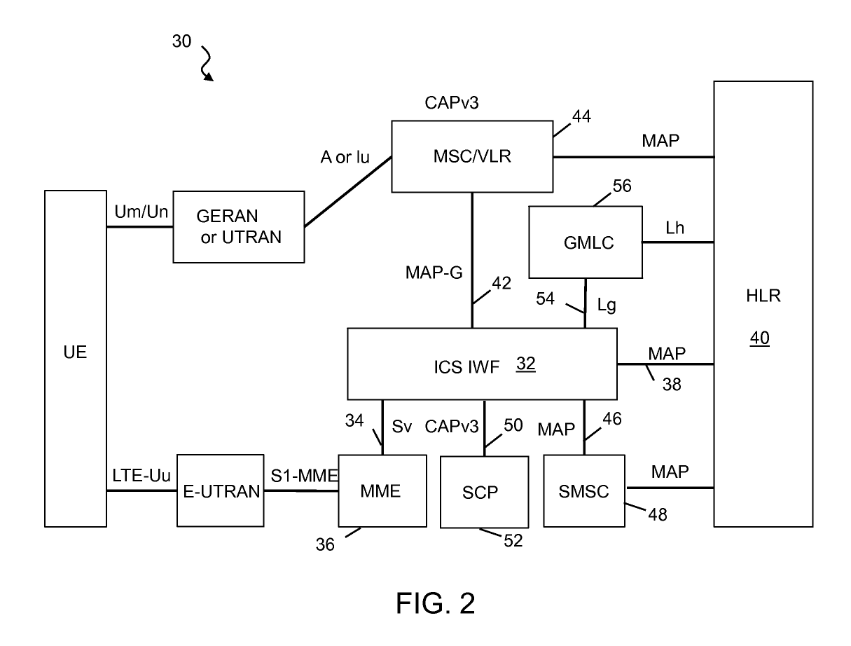

FIG. 2 is a simplified block diagram of an exemplary embodiment of ICS IWF (Interworking Function) interface architecture 30 according to the present disclosure. The ICS IWF 32 is an interworking function that provides support for ICS without requiring i2 interface support on the MSC. The ICS IWF functions as the serving MSC/VLR when an ICS-enabled subscriber either originates a new call from legacy radio access or receives a call while on legacy radio access. The ICS IWF 32 supports the Sv interface 34 to the Mobility Management Entity (MME) 36, a control node in the LTE access network, to enable the ICS IWF 32 to appear as a Visitor Location Register (VLR). The ICS IWF 32 supports the MAP (Mobile Application Part) interface 38 to the Home Location Register (HLR) 40 for location management, subscriber management, and call handling procedures. The ICS IWF 32 also supports the MAP-G interface 42 to the MSC/VLR 44 to enable it to access and retrieve the International Mobile Subscriber Identifier (IMSI) information and unused authentication vectors. The ICS IWF 32 further supports the MAP interface 46 to the Short Message Service Center (SMSC) 48 to enable mobile-originated and mobile-terminated Short Message Service (SMS). The ICS IWF 32 further supports the CAMEL (Customized Applications for Mobile Enhanced Logic) Application Protocol CAPv3 interface 50 to the Signaling Control Point (SCP) 52, an IN node, to provide mobile-originated and mobile-terminated SMS prepaid services using the information retrieved from the HLR 40. The ICS IWF 32 also supports an Lg interface 54 to Gateway Mobile Location Center (GMLC) 56 for mobile-terminated location requests.

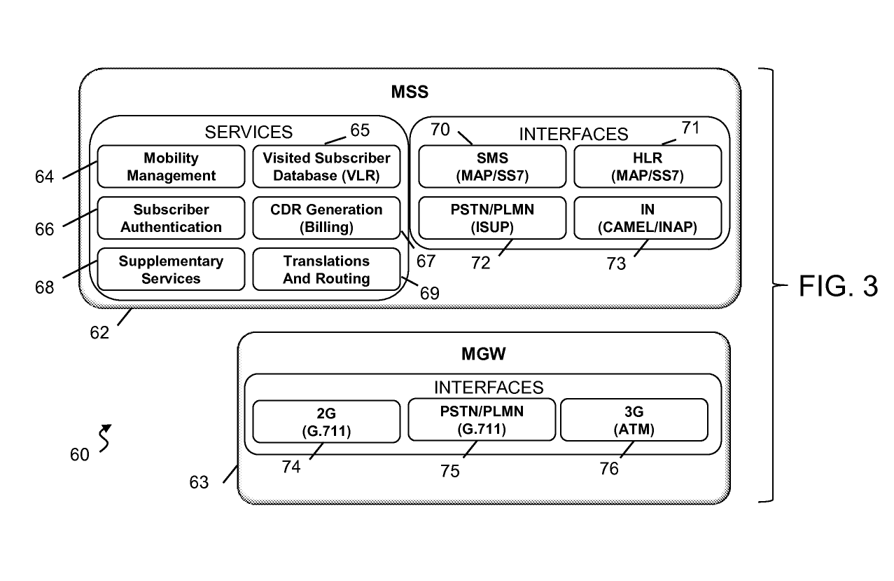

FIGS. 3-5 are simplified block diagrams of an exemplary embodiment of how the MSC has evolved and may evolve toward ICS support according to the present disclosure.

Referring first to FIG. 3 illustrating a distributed MSC 60 in which the MSC is logically and functionally separated into two parts—MSC server (MSS) 62 and Media Gateway (MGW) 63, with a standardized IP-based interface between them. The MSS 62 is the brain of the voice switching system and supports services including: mobility management 64, visited subscriber database 65, subscriber authentication 66, Call Detailed Record (CDR) generation for billing purposes 67, supplementary services 68, and translation and routing 69. The MSS 62 further includes MAP and/or SS7 interfaces 70 to SMS, MAP and/or SS7 interfaces 71 to HLR, ISDN (Integrated Service Digital Network) User Part (ISUP) interfaces 72 to PSTN and/or PLMN, and CAMEL and/or Intelligent Network Application Protocol (INAP) interfaces 73 to IN.

The MSS 62 communicates with the MGW 64 via an IP interface. The MGW 63 is responsible for setting up the speech path way between the two UEs in a call. The MGW 63 includes interfaces 74 and 75 to the 2G and PSTN/PLMN networks via G.711. The MGW 64 further includes an interface 76 to 3G or Universal Mobile Telecommunications System (UMTS) radio network via Asynchronous Transfer Mode (ATM).

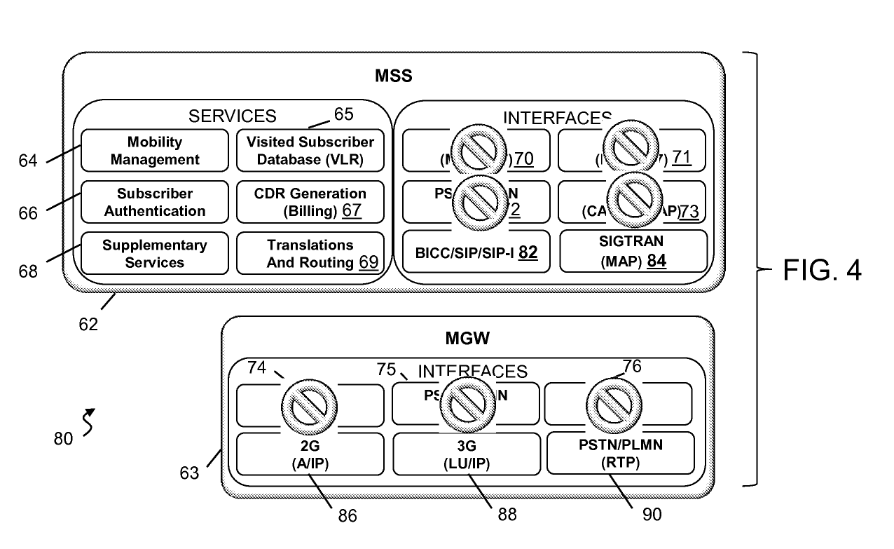

Referring to FIG. 4, a next step in MSC evolution involves adding IP interfaces in order to communicate using IP-based connections for GSM and UMTS access. Messages and signaling are converted to be transported over IP. The MSC becomes an IP-based system and all messages between the MSC and the radio access network pass an SS7-to-IP gateway so that SS7 messages can be transported over an IP connection. In the MSS 62, SMS (MAP/SS7) 70, HLR (MAP/SS7) 71, PSTN/PLMN (ISUP) 72, and IN (CAMEL/INAP) 73 interfaces are eliminated. Instead, core network connectivity is simplified by the introduction of BICC/SIP/SIP-I (Bearer Independent Call Control/Session Initiation Protocol/SIP—with Encapsulated ISUP) 82 and SIGTRAN (MAP) 84 interfaces. In the MGW 63, 2G interface 74 over G.711, 3G interface 75 over ATM, and PSTN/PLMN interface 76 over G.711 have been eliminated, and instead A over IP and lu over IP interfaces 86 and 88 for 2G and 3G networks have been introduced to simplified radio access connectivity. Further, PSTN/PLMN connectivity is also optimized over IP using Real-time Transport Protocol (RTP) 90.

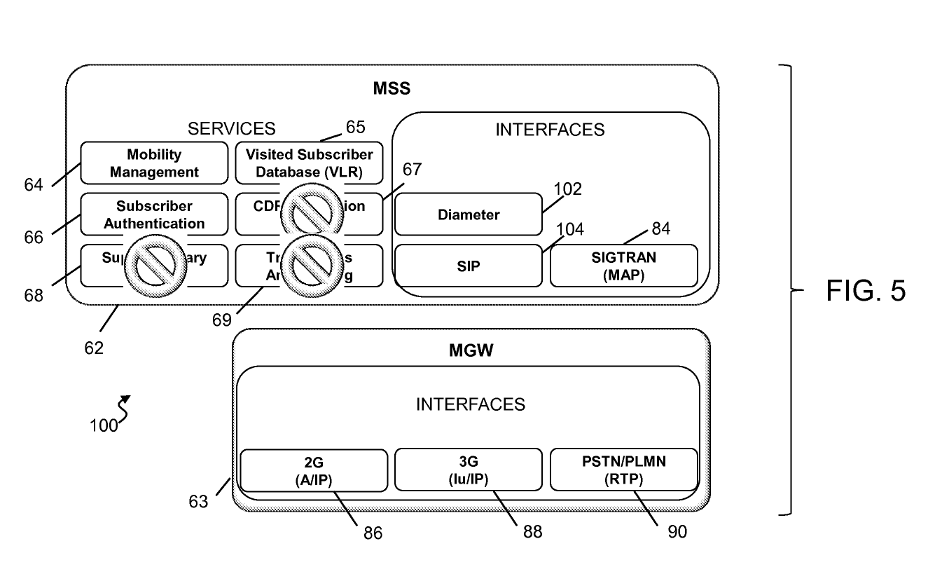

Referring to FIG. 5, moving toward ICS, the MSC further evolves by moving billing generation services 67, MSS service logic 68, and network translation and routing logic 69 to the IMS core network. An Sh interface 102 based on the Diameter protocol primarily used for authentication, authorization, and accounting is introduced in the MSS 62. MGW 63 performs IP-IP interworking.

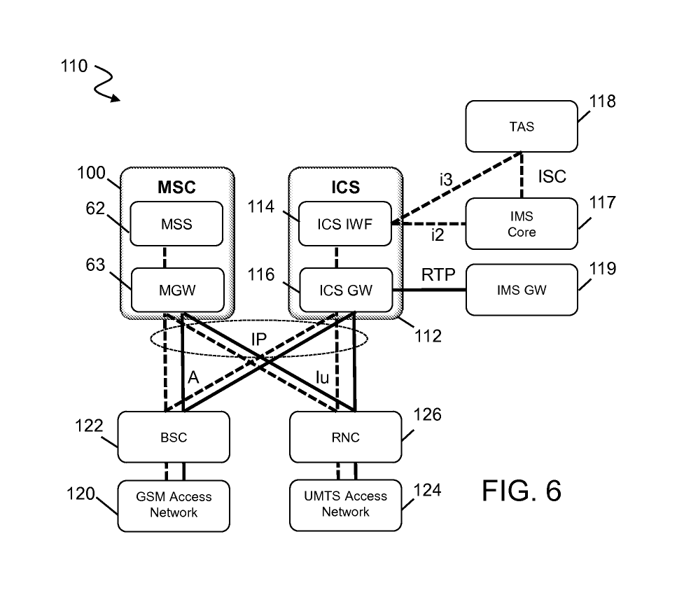

FIG. 6 is a simplified block diagram of an exemplary embodiment of ICS IWF/GW architecture 110 optimized for SIP/IP according to the present disclosure. The architecture 110 employs ICS 112 having two functional blocks, ICS IWF 114 and ICS GW 116. In FIG. 6, solid lines represent bearer channels and dashed lines represent signaling channels. The ICS IWF 114 performs services such as subscriber authentication, mobility management, converts legacy RAN call-related signaling with the IMS core network 117 to and from SIP via an i2 interface, convert legacy profile modification requests with Telephony Application Server (TAS) 118 to SIP via an i3 interface, and send Diameter protocol-based billing information to the server or network entity performing the Charging Collection Function (CCF). The IMS Core network includes SIP servers, including Serving-Call Session Control Function (S-CSCF) (handles SIP registration, routing service, etc.), Proxy-CSCF (P-CSCF) (an SIP proxy server), Interrogating-CSCF (I-CSCF). The IMS Core network also includes the Home Subscriber Server (HSS) subscriber database. In general, the HSS database may contain user profiles (i.e., subscription-related information), including various user and device identifiers or IDs such as International Mobile Subscriber Identity (IMSI), Temporal Mobile Subscriber Identity (TMSI), International Mobile Equipment Identity (IMEI), Mobile Subscriber ISDN Number (MSISDN), Universally Unique Identifier (UUID), as well as additional IMS-specific identities such as IM Multimedia Private Identity (IMPI) and IP Multimedia Public Identity (IMPU) that are implemented as Tel-Uniform Resource Identifiers (URIs) or SIP-URIs. Whereas the IMPI is unique to a particular user in a 3GPP system or could be unique to a particular UE device in another technology, it is possible to have multiple Public Identities (i.e., IMPUs) per IMPI. Further, the IMPU can also be shared with IMPI such that two or more devices can be reached with the same identity (e.g., a single phone number for an entire family). The IMS core network 117 and the TAS 118 communicate via the IP Multimedia Service Control (ISC) interface, which uses SIP signaling protocol. The ICS GW 116 converts IP-based legacy bearer traffic to and from the IMS GW 119 using RTP. The legacy MSC 100 is preserved for handling inbound roaming UEs who are not IMS enabled. Accordingly, the MSC 100 and the ICS 112 provide services to UEs via the GSM access network 120 and the Base Station Controller (BSC) 122, and to UEs via the UMTS access network 124 and Radio Network Controller (RNC) 126. The access is over A or lu over IP interfaces.

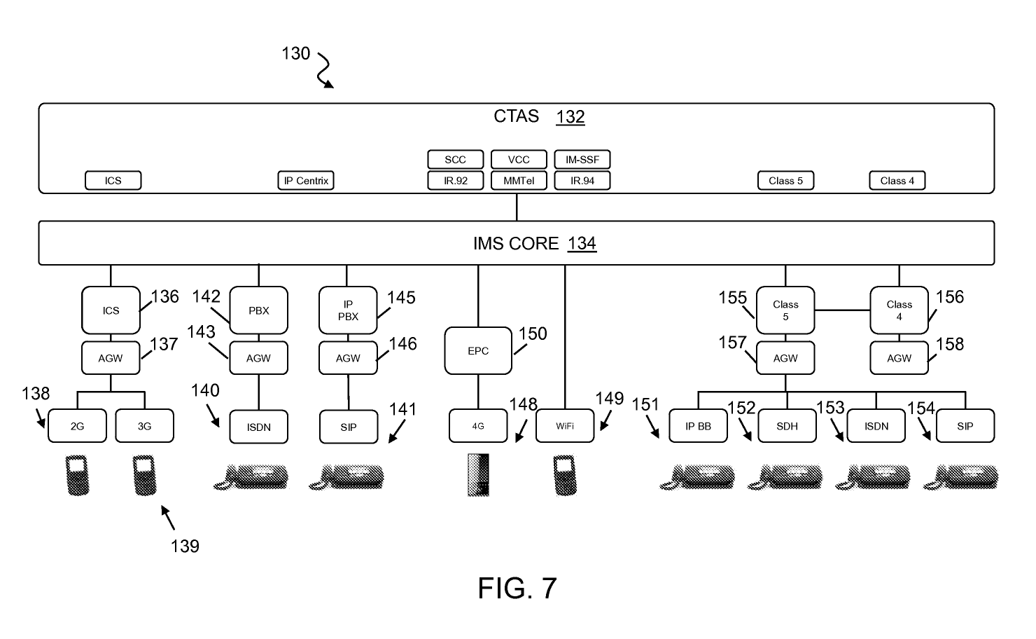

FIG. 7 is a simplified block diagram of an exemplary embodiment of an IMS architecture 130 according to the present disclosure. The Converged Telephony Application Sir (CTAS) 132 is a scalable carrier-grade Multimedia Telephony Application Server that provides voice and video services to IMS/SIP clients over any IMS-enabled access type, e.g. LTE, Wi-Fi, HSPA, etc. It supports Mobile VoIP (Voice over Wi-Fi) and Voice over LTE (VoLTE) as well as Mobile Video Calling. The CTAS 132 is communicatively coupled to the IMS Core 134 and provides all services in the IMS domain. The CTAS 132 supports communication with the ICS 136 and access gateway (AGW) 137 for servicing 2G and 3G mobile devices 138 and 139. The CTAS 132 also provides support to IP Centrix applications and devices 140 and 141 via ISDN andf SIP, via the Private Branch Exchange (PBX) 142, AGW 143, IP PBX 145, and AGW 146. The CTAS 132 further provides support for 4G LTE devices 148 and WiFi devices 149 via the Evolved Packet Core (EPC) 150 to provide services including Service Centralization and Continuity (SCC), Voice Call Continuity (VCC) to provide voice call continuity between CS and IMS domains, IP Multimedia Service Swithing Function (IM-SSF), IR.92 (a GSMA VoLTE specification), Multimedia Telephony (MMTe1), and IR.94 (a GSMA VoLTE specification). The CTAS 132 also provides support for the fixed IP BB, SDH, ISDN, SIP telephony devices 151-154 that are serviced by Class 5 and Class 4 switches 155 and 156 and AGWs 157 and 158. Accordingly, with the vast number of different types of access networks, IMS provides seamless services access and continuity between these networks.

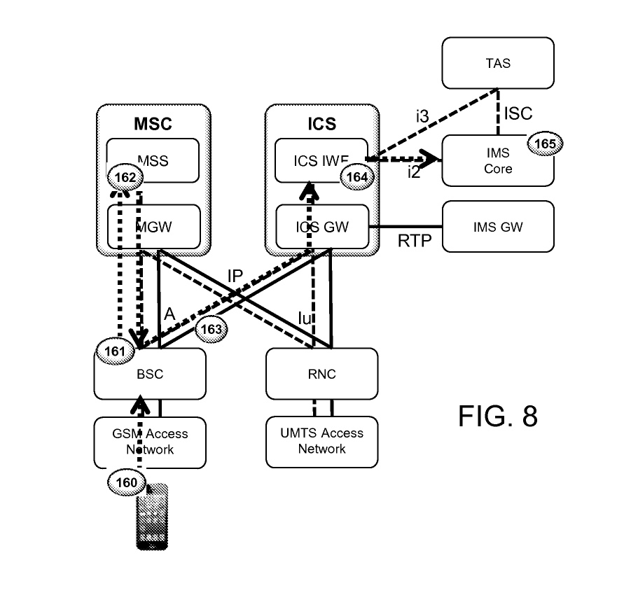

FIG. 8 is a simplified block diagram of an exemplary embodiment of a registration process of a pre-Release 6 UE with default domain set to CS according to the present disclosure. The UE may register (attach) in the CS domain whenever in CS coverage. The existing mobility management mechanisms are used in the UE and the CS network. The UE registers with the 2G GSM access network using the default PLMN identifier (160). The BSC routes the registration request message to the default network via the MSC, which is in the Circuit-Switched domain (161). The MSC attempts to register the subscriber, however the subscriber is not in the HLR, and a failure reply is returned to the BSC (162). The BSC then routes the registration request message to the network in the IMS domain (163), where the ICS, acting as a “MSC,” is provisioned as a second network. The ICS IWF routes the registration request message to the IMS Core network over the i2 interface (164). The IMS Core network registers the subscriber in the Home Subscriber Server (HSS) (165).

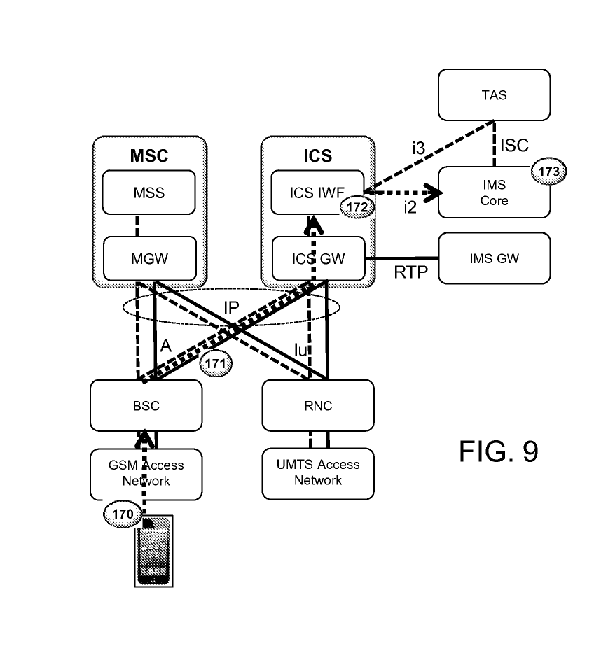

FIG. 9 is a simplified block diagram of an exemplary embodiment of registration of a Release 6 ICS-enabled UE according to the present disclosure. The UE registers with the 2G GSM access network using the ICS PLMN identity (170). The BSC routes the registration request message to the ICS IWF (171). The ICS IWF routes the registration request message to the IMS Core network over the i2 interface (172). The IMS Core then registers the subscriber in the HSS (173).

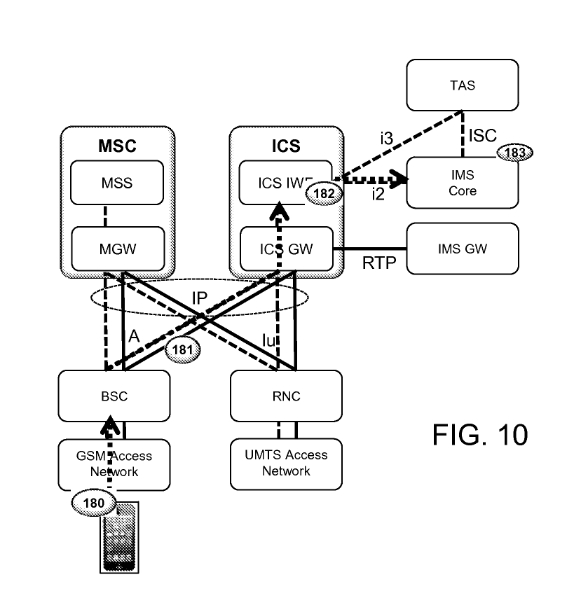

FIG. 10 is a simplified block diagram of an exemplary embodiment of mobile-originated ICS call according to the present disclosure. The UE initiates a call on the 2G network (180). The BSC routes the call to the ICS IWF (181). The ICS IWF routes the call to the IMS Core network, where the call setup signaling is sent over the i2 interface (182). The IMS Core network performs origination services and routes the call to the terminating device (183), where the call is anchored in SCC, and the originating services are performed by the TAS.

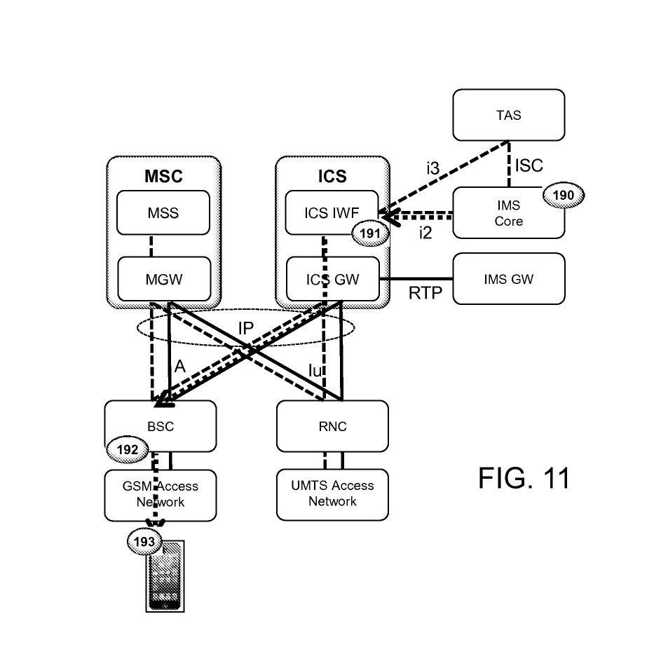

FIG. 11 is a simplified block diagram of an exemplary embodiment of mobile terminated ICS call according to the present disclosure. The IMS Core network performs termination services and routes the call to ICS IWF (190). The call is anchored in SCC and the terminating services are performed by TAS. The ICS IWF routes the call to the BSC, where the call setup signaling is sent over the A interface (191). The BSC then routes the call to the UE (192), and the UE terminates the call (193).

As the term is used herein, a User Equipment or UE may be any tethered (wired) or untethered (wireless) communications device, which may include any computer (e.g., desktops, laptops, palmtops, or handheld computing devices) equipped with a suitable wireless modem or a mobile communications device (e.g., cellular phones or data-enabled handheld devices capable of receiving and sending messages, web browsing, etc.), or any enhanced PDA device or integrated information appliance capable of email, video mail, Internet access, corporate data access, messaging, calendaring and scheduling, information management, and the like. In general, a UE device may be capable of operating in multiple modes in that it can engage in both Circuit-Switched (CS) as well as Packet-Switched (PS) communications, and can transition from one mode of communications to another mode of communications without loss of continuity. Furthermore, those skilled in the art will recognize that a UE may sometimes be treated as a combination of a separate mobile equipment or device and an associated memory module.

The features of the present invention which are believed to be novel are set forth below with particularity in the appended claims. However, modifications, variations, and changes to the exemplary embodiments described above will be apparent to those skilled in the art, and the system and method described herein thus encompasses such modifications, variations, and changes and are not limited to the specific embodiments described herein.

What is claimed is:

1. An IP Multimedia Subsystem (IMS) Centralized Services (ICS) Interworking Function (IWF) element comprising:
an i2 interface to an IMS core network;
an i3 interface to a Telephony Application Server (TAS);
a Mobile Applications Part-G (MAP-G) interface to a Mobile Switching Center (MSC) for retrieving subscriber identity;
a MAP interface to a Home Location Register (HLR) for location management, subscriber management and call handling procedures; and
an Sv interface to a Mobility Management Entity (MME) for appearing as a Visitor Location Register (VLR).

2. The ICS IWF according to claim 1, further comprising a Lg interface to Gateway Mobile Location Center (GMLC) for processing mobile-terminated location requests.

3. The ICS IWF according to claim 1, further comprising a MAP interface to a Short Message Service Center (SMSC) for processing mobile-originated and mobile-terminated Short Message Service (SMS) messages.

4. The ICS IWF according to claim 1, further comprising an IP interface to an ICS Gateway (GW) element operable to interface with an IMS GW over RTP and with access networks using A and lu interfaces over IP.

5. The ICS IWF according to claim 1, further comprising a Customized Applications for Mobile Enhanced Logic (CAMEL) Application Protocol (CAPv3) interface for communicating with a Signal Controlling Point (SCP).

6. The ICS IWF according to claim 1, further comprising X1 and X3 interfaces used for lawful interception of mobile-originated and mobile-terminated short messages.

7. An method for IP Multimedia Subsystem (IMS) Centralized Services (ICS) Interworking Function (IWF) comprising:
interfacing with an IMS core network using an i2 interface;
interfacing with a Telephony Application Server (TAS) using an i3 interface;
interfacing with a Mobile Switching Center (MSC) for retrieving subscriber identity using a Mobile Application Part-G (MAP-G) interface;
interfacing with a Home Location Register (HLR) for location management, subscriber management and call handling procedures using a MAP interface; and
interfacing with a Mobility Management Entity (MME) for appearing as a Visitor Location Register (VLR) using an Sv interface.

8. The method according to claim 7, further comprising interfacing with a Gateway Mobile Location Center (GMLC) for processing mobile-terminated location requests using a Lg interface.

9. The method according to claim 7, further comprising interfacing with a Short Message Service Center (SMSC) for processing mobile-originated and mobile-terminated Short Message Service (SMS) messages using a MAP interface.

10. The method according to claim 7, further comprising interfacing with an ICS Gateway (GW) element using an IP interface, the ICS GW operable to interface with an IMS GW over RTP and with access networks using A and lu interfaces over IP.

11. The method according to claim 7, further comprising interfacing with a Signal Controlling Point (SCP) using a Customized Applications for Mobile Enhanced Logic (CAMEL) Application Protocol (CAPv3) interface.

12. The method according to claim 7, further comprising using X1 and X3 interfaces for lawful interception of mobile-originated and mobile-terminated short messages.

13. The method according to claim 7, further comprising registering a User Equipment (UE) with default domain set to Circuit-Switched access network by:
receiving, via the ICS GW, a request to register the UE from a Base Station Subsystem (BSC) via an A interface over an IP link; and
sending the registration request to an IMS core network over an i2 interface.

14. The method according to claim 7, further comprising registering an ICS-enabled User Equipment (UE) by:
receiving, via the ICS GW, a request to register the UE from a Base Station Subsystem (BSC) via an A interface over an IP link; and
sending the registration request to an IMS core network over an i2 interface.

15. The method according to claim 7, further comprising setting up a mobile-originated ICS call originated from a User Equipment (UE) by:
receiving, via the ICS GW, a request to set up a call originated from the UE from a Base Station Subsystem (BSC) via an A interface over an IP link; and
sending the call setup request to an IMS core network over an i2 interface.

16. The method according to claim 7, further comprising setting up a mobile-terminated ICS call to a User Equipment (UE) by:
receiving a call setup request from an IMS core network over an i2 interface; and
sending, via the ICS GW, the call setup request to a Base Station Subsystem (BSC) via an A interface over an IP link.
